(19) United States
(12) Patent Application Publication
(10) Pub. No.: US 2011/0212228 A1
(43) Pub. Date: Sep. 1, 2011

(54) LEAVENING COMPOSITION FOR REFRIGERATED DOUGH PRODUCTS

(76) Inventors: Bruce W. Robb, St. Louis Park, MN (US); Liza B. Levin, Plymouth, MN (US); Abdel Abdelrahman, Woodbury, MN (US)

(21) Appl. No.: 13/128,037

(22) PCT Filed: Nov. 3, 2009
(86) PCT No.: PCT/US09/63039

§ 371 Date: May 6, 2011

Related U.S. Application Data
(60) Provisional application No. 61/116,833, filed on Nov. 21, 2008.

(51) Int. Cl. A21D 10/02; A21D 2/00; B65B 31/00

(52) U.S. Cl. 426/128; 426/561

(57) ABSTRACT

A refrigerated dough system including a dough product contained in a package is described. The dough product includes an unencapsulated base, an unencapsulated expansion leavening acid, and an unencapsulated pressurization leavening acid. The pressurization leavening acid may be a calcium-based leavening acid. This refrigerated dough system makes it possible to achieve or exceed the critical rate of gas evolution for a particular product while improving the nutritional properties of the product. Also described is a method of making a refrigerated dough product. This method involves making a dough from ingredients including an unencapsulated base, an unencapsulated expansion leavening acid, and an unencapsulated pressurization leavening acid. The dough is placed within a package, which is sealed from within by action of the expansion leavening acid and the base. Pressure is then generated inside the package by action of the pressurization leavening acid and the base.

### BACKGROUND

Refrigerated, canned dough products have been very popular with consumers. In addition to the ease of use of canned dough products, the quality of the baked products made from refrigerated, canned dough has vastly improved over the years.

As consumers demand more high quality, nutritious food products, consumer food product manufacturers work to continue to develop food products that meet these consumer demands. Balancing the nutrition profile of a food product with its desired organoleptic properties has often been a challenge to consumer food product manufacturers. As such, manufacturers seek to increase the nutritive value of a food product without noticeably altering its organoleptic properties by using food ingredients that have the requisite functional properties but have added nutritive value, such as added vitamins and minerals.

Refrigerated dough product manufacturers, in addition to facing the nutrition demands of consumers, are faced with the challenge of meeting these demands while working within the constraints associated with refrigerated dough product manufacturing, which in large part revolve around optimizing the rate of carbon dioxide gas generation in a canned dough system. Such optimization makes it possible to rapidly expand the dough to reach a desired volume, thereby reducing headspace gas volume and the concomitant loss in dough and finished product quality. The initial expansion of the leavened dough to seal a ventable can from within is followed by an increase in the pressure within the can resulting from the continued carbon dioxide generation by the leavening agents. The pressure increase and gas generation help to build and sustain the internal gas cell structure of the dough, which results in excellent finished product characteristics typically associated with leavened dough products.

The ability to optimize the rate of carbon dioxide generation in a canned dough system has, however, been a challenge to refrigerated dough manufacturers for decades. Without such optimization, a canned refrigerated dough product suffers from not sufficiently proofing and expanding to seal the can, which results in irreversible product failure. Refrigerated dough manufacturers therefore constantly strive to develop and utilize ingredients, formulations, systems and processes to attain the optimum rate of carbon dioxide generation in refrigerated dough products on a commercial scale.

It has been uniquely challenging for refrigerated canned dough manufacturers to provide consumers with food products with an increased nutritive value while attempting to optimize carbon dioxide generation because of the delicate balance of ingredients, formulations, systems and processes required to achieve a suitable refrigerated dough product. Even ingredients that are intended to be used in dough products often do not meet the complex requirements of a refrigerated canned dough system.

One example of such an ingredient is a calcium-based leavening acid, such as calcium acid pyrophosphate. Calcium based leavening acids, while having many desirable properties, have typically been difficult to use in canned or packaged refrigerated dough systems because these leavening acids generally do not react fast enough to generate carbon dioxide at or above a critical rate of gas evolution, and therefore are unable to suitably expand the dough to seal the package or can from within, and then pressurize the dough within the package or can. As such, calcium-based leavening agents, although having the benefit of potentially increasing the calcium level and decreasing the sodium level of products made from dough, have not typically been used in the industry to manufacture refrigerated canned dough products.

### SUMMARY

It has been unexpectedly discovered that by using leavening agents, which are typically encapsulated, in their unencapsulated form, in combination with a calcium-based leavening acid, it is possible to achieve or exceed the critical rate of gas evolution for a particular product while improving the nutritional properties of the product.

The present invention is directed to a refrigerated dough system which includes a dough product contained in a package. The dough product includes a base, an expansion leavening acid, and a pressurization leavening acid. The pressurization leavening acid may be a calcium-based leavening acid. The base, expansion leavening acid, and pressurization leavening acid are each unencapsulated. The expansion leavening acid, when combined with the base, is capable of generating gas which causes the dough product to expand to a degree sufficient to seal the package from within. The pressurization leavening acid, when combined with the base, is capable of generating gas within the dough product to pressurize the dough product after the package is sealed. The internal system pressure is sustained inside the package under refrigeration conditions over a period of time. This internal system pressure is less than the pressure sustained by the expansion leavening acid at a 100% neutralizing value in a similar dough product, and greater than the pressure sustained by the pressurization leavening acid at a 100% neutralizing value in a similar dough product.

The present invention is also directed to a method of making a refrigerated dough product. This method involves mixing dough ingredients, including an unencapsulated leavening base, an unencapsulated expansion leavening acid, and an unencapsulated pressurization leavening acid, together to make a dough. The dough is then placed inside a ventable package with an opening. The opening of the package is subsequently closed to create a headspace including air inside the package. After the opening is closed, the package is sealed from within by action of the expansion leavening acid and the base, which together generate gas in the dough to expand the dough, thereby venting out the air in the headspace and filling the headspace with expanded dough. Pressure is then generated inside the package by action of the pressurization leavening acid and the base, which together generate additional gas in the expanded dough.

### BRIEF DESCRIPTION OF THE DRAWINGS

FIG. 1 shows plots of can pressure, after 24 hours, versus the weight of the canned dough for dough products prepared using the following leavening acids: glucono-delta-lactone (GDL) as the sole leavening acid at a 25% neutralizing value; LEVONA® leavening agent as the sole leavening acid at a 75% neutralizing value; and a combination of GDL at a 25% neutralizing value and LEVONA® leavening agent at a 75% neutralizing value.

FIG. 2 shows plots of can pressure, after 24 hours, versus the weight of the canned dough for dough products prepared using the following leavening acids: GDL as the sole leavening acid at a 25% neutralizing value; LEVONA® leavening agent as the sole leavening acid at a 75% neutralizing value; and a combination of GDL at a 25% neutralizing value and LEVONA® leavening agent at a 75% neutralizing value.

FIG. 3 shows plots of can pressure, after 24 hours, versus the weight of the canned dough for dough products prepared using the following leavening acids: LEVONA® leavening agent at a 100% neutralizing value; a combination of LEVONA® leavening agent at a 90% neutralizing value and GDL at a 10% neutralizing value; a combination of LEVONA® leavening agent at a 80% neutralizing value and GDL at a 20% neutralizing value; a combination of LEVONA® leavening agent at a 70% neutralizing value and GDL at a 30% neutralizing value; and a combination of LEVONA® leavening agent at a 60% neutralizing value and GDL at a 40% neutralizing value.

FIG. 4 shows plots of volume of CO₂ evolved over time for dough products prepared using the following leavening acids: GDL at a 100% neutralizing value; CAL-RISE® calcium acid pyrophosphate leavening agent at a 100% neutralizing value; GDL at a 25% neutralizing value; CAL-RISE® leavening agent at a 75% neutralizing value; and a combination of GDL at a 25% neutralizing value and CAL-RISE® leavening agent at a 75% neutralizing value.

FIG. 5 shows plots of volume of CO₂ evolved over time for dough products prepared using the following leavening acids: GDL at a 100% neutralizing value; LEVONA® leavening agent at a 100% neutralizing value; GDL at a 25% neutralizing value; LEVONA® leavening agent at a 75% neutralizing value; and a combination of GDL at a 25% neutralizing value and LEVONA® leavening agent at a 75% neutralizing value.

### DESCRIPTION

Leavening agents having various rates of carbon dioxide generation have been used to prepare canned refrigerated dough products. The problems associated with using these leavening agents stem from their very nature—the slow-acting leavening agents generate carbon dioxide so slowly that some of the generated gas escapes out of the package before the dough is sufficiently proofed to fill and seal the package, rather than being entrapped within the dough, causing poor dough conditions and volume. In addition, slow-acting leavening agents that contain phosphates may have taste issues that limit their use and may require additional ingredients to achieve the desired taste profile in the finished product.

Fast-acting leavening agents, on the other hand, generate carbon dioxide quickly, sometimes while the dough ingredients are being mixed, so the dough begins to expand before it is suitably packaged to retain the gas within the dough. To overcome the problems associated with fast-acting leavening agents, one or more of the leavening components (acid and/or base) are encapsulated to slow the reaction rate. Encapsulated leavening agents are typically much more expensive than conventional leavening agents, and are not entirely problem free, as the encapsulation material may still prematurely release the leavening agent. Other methods of “sequestering” one or more of the fast-acting leavening agents is by laminating the dough, as described in U.S. Pat. No. 4,526,801.

The leavening composition in accordance with the present invention can be used to make a packaged dough product of the present invention, wherein the dough in the package is sufficiently expanded to seal the package from within, and the package is sufficiently pressurized by the dough expansion to retain gas within the dough, which ultimately results in desirable baked product characteristics. The package may be a ventable composite can, such as the packages described in U.S. Pat. Nos. 3,510,050 and 3,879,563. Other types of ventable cans and other ventable packaging are also contemplated to be suitable for use in accordance with the present invention. “Ventable can” as used herein shall refer to any can or other package having at least one vent through which headspace air may escape from the can as the dough expands inside the can to seal the can from within.

In one embodiment of the present invention, the dough product includes a leavening composition comprising an unencapsulated leavening base and a blend of leavening acids. The leavening acids include an expansion leavening acid and a pressurization leavening acid. Either or both of the expansion leavening acid and pressurization leavening acid can be unencapsulated. The expansion leavening acid is capable of generating gas when combined with the base to initially proof and expand the dough product to a degree sufficient to cause the dough to seal the package from within the package. The pressurization leavening agent is capable, when combined with the base, of generating gas within the dough product to subsequently pressurize the dough product inside the sealed package in an amount sufficient to sustain an internal system pressure inside the package under refrigeration conditions over a period of time. This period of time ranges from about 1 day to about 120 days.

In this embodiment, the internal system pressure of the dough product, inside the package under refrigeration conditions over a period of time, is lower than the pressure that is sustained by the expansion leavening acid acting individually at a 100% neutralizing value in a similar dough. The internal system pressure of the dough product, inside the package under refrigeration conditions over a period of time, is also greater than the pressure that is sustained by the pressurization leavening acid acting individually at a 100% neutralizing value in a similar dough.

As used herein, the expression “neutralizing value” refers to a level of the leavening acid required to react with and neutralize the recited percentage of the leavening base in a given product. The period of time can range from about 1 day to about 120 days, for example, from about 30 days to about 90 days. The internal system pressure can range from about 8 psi to about 20 psi, for example, from about 10 psi to about 20 psi.

In this embodiment, the expansion leavening acid and the pressurization leavening acid are present in the dough at a ratio of from about 10:90 to about 40:60, prior to reacting with the base. At least one of the expansion leavening acid and the pressurization leavening acid is substantially free of sodium.

The expansion leavening acid may be a fast-acting leavening agent, such as, but not limited to, glucono-delta-lactone and sodium acid pyrophosphate. Useful examples of expansion leavening acids are those that are capable of causing sufficient dough expansion to seal a can from inside the can at temperatures ranging from about 40° F. to about 70° F. for a period of time sufficient to seal the can, depending, among other things, on the internal can volume and the amount of dough placed inside the can. In some cases, the period of time for sealing the can varies from about 24 hours to about 72 hours after the dough is placed inside the ventable can through its open end and the open end is closed.

The pressurization leavening acid may be a slow-acting leavening agent such as, but not limited to, calcium acid pyrophosphate. Possible slow-acting leavening agents include the CAL-RISE® leavening agent, which is available from Innophos, Inc. of Cranbury, N.J., US, and LEVONA® leavening agents, which are available from ICL Performance Products LP of St. Louis, Mo., US. Possible LEVONA® leavening agents for use in this invention include LEVONA® OPUS leavening agent, LEVONA® BR10 leavening agent, and LEVONA® MEZZO leavening agent.

Although the types of leavening acids have been described herein as “expansion” and “pressurization”, those skilled in the art will appreciate that these expressions describe the major function of the leavening acids, but are not intended to preclude each type of leavening acid from performing other functions to a lesser degree as well. For example, although a faster acting expansion leavening agent serves primarily to quickly expand the dough, the same leavening agent may, to some degree, assist with pressurizing the dough over time. Similarly, even though the slower acting pressurization leavening acid serves primarily to generate gas within the dough to sustain an internal pressure within the package over time after the dough has been packaged, the same leavening acid may, to some extent, contribute to the initial dough expansion.

While not intending to be bound by theory, it is believed that there is a critical rate of gas evolution required in a dough product, below which the carbon dioxide diffuses out of the canned dough and escapes out of the vent or vents in the can, but above which the dough can proof and expand to seal the ventable can from within, following which the necessary pressure within the can may be generated by continued gas evolution. This rate of gas evolution is dependent on many conditions, such as the type of dough and leavening agent, the package volume, and the like.

The following examples demonstrate the principles involved in the present invention, but are not intended to limit the scope of the invention. All dough products described herein comprise flour, water, and a leavening system, but those skilled in the art will understand that the present invention encompasses dough products comprising additional dough ingredients, such as, but not limited to, plasticizers, stabilizers, conditioners, emulsifiers, flavoring agents, coloring agents, particulate materials, preservation agents, and the like.

### Example I

The overall can pressure of a canned dough product is affected by individual component contributions to can pressure and by the rate of reaction and interactions within the packaged dough system. Can pressures greater than those attained through the use of individual leavening components can be achieved by manipulating the reaction rate of the leavening agents in the dough to achieve the critical rate of gas evolution.

When calcium acid pyrophosphate is used alone as a leavening acid, the proofing is insufficient to promote effective can pressure. Therefore, the use of calcium acid pyrophosphate, such as LEVONA® leavening agent, as the sole leavening acid does not result in an acceptable canned dough product. The LEVONA® leavening agent acting alone will not develop acceptable can pressure, even when the leavening acid is at a 100% neutralizing value.

When glucono-delta-lactone (GDL) is used alone as a leavening acid at a low level, a low can pressure is also observed. Furthermore, if the level of GDL is increased, although more gas is generated, it is generated at a rate that is too fast to suitably package the dough. In many cases, if the level of GDL in the dough is increased, the resulting pressure leads to package failure. For these reasons, GDL is conventionally used with an encapsulated base, typically known as “e-soda”. GDL may itself be used in an encapsulated form to delay the onset of the leavening reaction.

When calcium acid pyrophosphate, such as LEVONA® leavening agent, and GDL are combined, there is a sufficient rate of reaction to initially expand the dough to seal the can, and to continue to proof the dough and develop acceptable can pressure. GDL or sodium acid pyrophosphate (SAPP), and many other leavening acids, can be used in conjunction with a leavening agent comprising calcium acid pyrophosphate to achieve appropriate dough expansion and can pressure development to promote effective proofing in canned dough products.

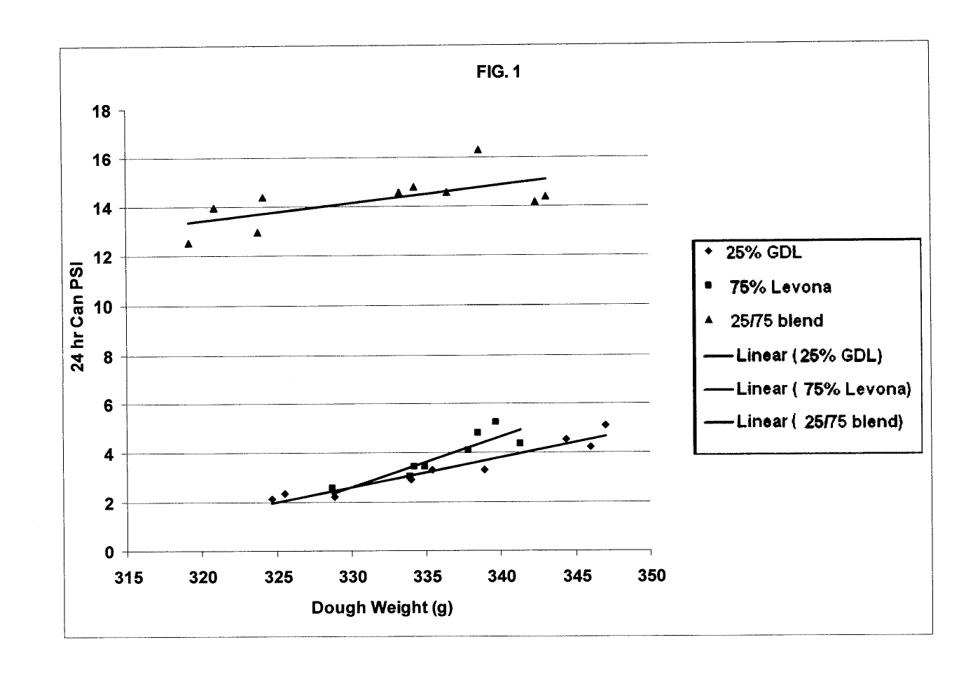

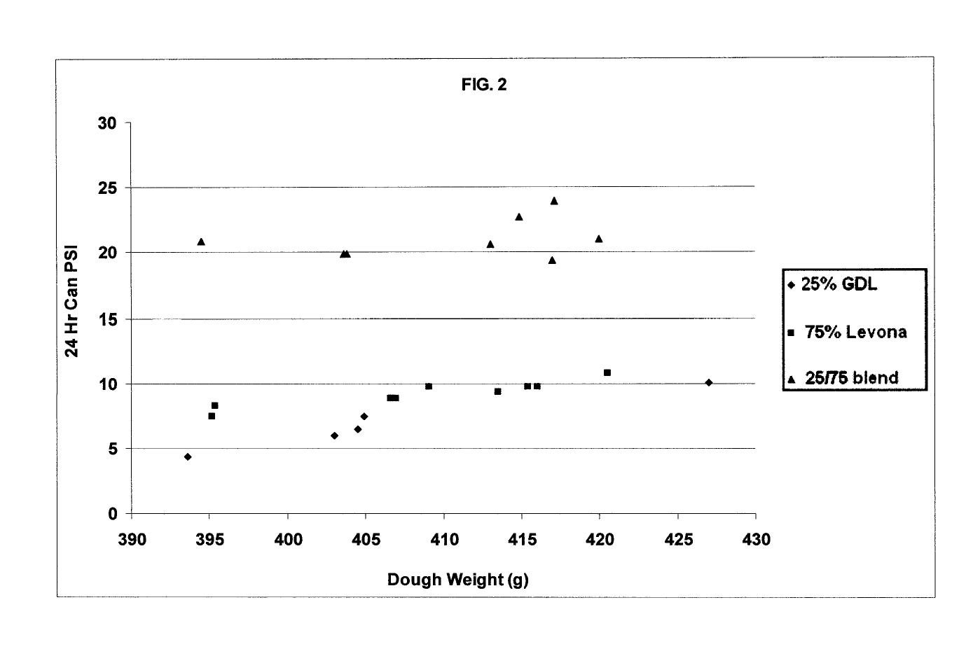

The can pressures of canned dough products using the following leavening acids were measured: 1) GDL at a 25% neutralizing value; 2) LEVONA® leavening agent at a 75% neutralizing value; and 3) a combination of GDL at a 25% neutralizing value and LEVONA® leavening agent at a 75% neutralizing value. Sodium bicarbonate was used as the leavening base, and all the leavening agents were unencapsulated. The results of these experiments are shown in the plots of FIGS. 1 and 2.

FIG. 1 shows plots of can pressure, after 24 hours, versus the weight of the canned dough used. As shown in this figure, when GDL is used as the sole leavening acid at a 25% neutralizing value, a can pressure of between about 2 psi and 6 psi is attained after 24 hours, for dough weights of between about 325 g and 350 g. Also, when LEVONA® leavening agent is used as the sole leavening acid at a 75% neutralizing value, a can pressure of between about 2 psi and 6 psi is attained after 24 hours. Therefore, neither of the leavening acids, acting alone, is capable of generating sufficient pressure within a canned dough product.

However, when a combination of GDL at a 25% neutralizing value and LEVONA® leavening agent at a 75% neutralizing value is used as the leavening composition, a can pressure of between about 12 psi and 16 psi is attained after 24 hours. Therefore, unexpectedly, the can pressure attained using the combination of the GDL and the LEVONA® leavening agent is greater than the sum of the pressures attained using the GDL and the LEVONA® leavening agents individually.

FIG. 2 also shows plots of can pressure, after 24 hours, versus the weight of the dough used. As shown in this figure, when GDL is used as the sole leavening acid at a 25% neutralizing value, a can pressure of between about 4 psi and 10 psi is attained after 24 hours, for dough weights of between about 390 g and 430 g. When calcium acid pyrophosphate, such as LEVONA®, is used as the sole leavening acid at a 75% neutralizing value, a can pressure of between about 7 psi and 11 psi is attained after 24 hours.

When a combination of GDL at a 25% neutralizing value and calcium acid pyrophosphate leavening agent at a 75% neutralizing value is used as the leavening composition, a can pressure of between about 19 psi and 24 psi is attained. Again, the combination of the expansion leavening agent, GDL, with the pressurization leavening agent, calcium acid pyrophosphate, resulted in the desired pressure ranges as compared to either leavening agent acting individually.

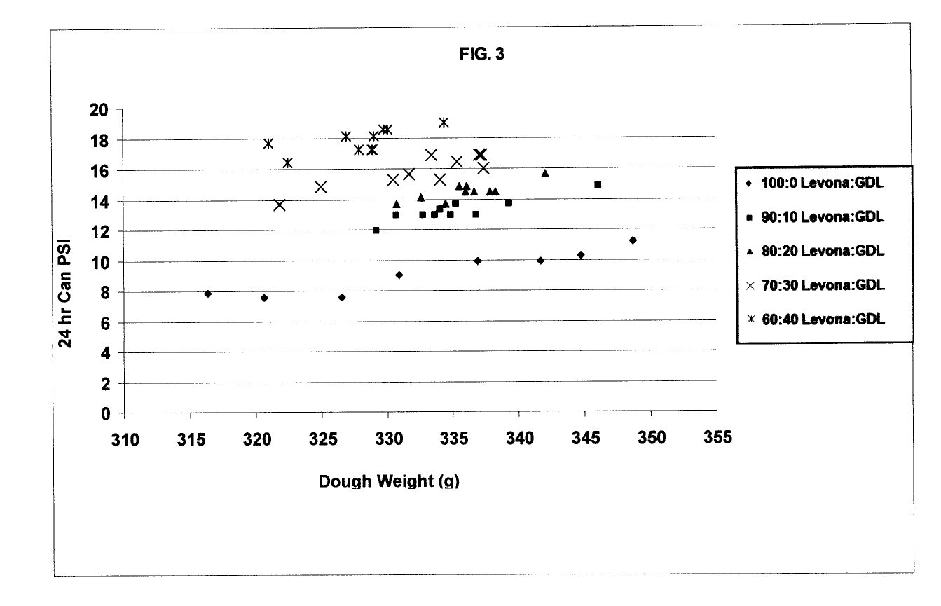

The can pressures of canned dough products using the following leavening acids were measured: 1) LEVONA® leavening agent at a 100% neutralizing value; 2) a combination of LEVONA® leavening agent at a 90% neutralizing value and GDL at a 10% neutralizing value; 3) a combination of LEVONA® leavening agent at a 80% neutralizing value and GDL at a 20% neutralizing value; 4) a combination of LEVONA® leavening agent at a 70% neutralizing value and GDL at a 30% neutralizing value; and 5) a combination of LEVONA® leavening agent at a 60% neutralizing value and GDL at a 40% neutralizing value. The results of these experiments are shown in the plots of FIG. 3.

FIG. 3 shows plots of can pressure, after 24 hours, versus the weight of the dough used. As shown in this figure, when LEVONA® leavening agent is used at a 100% neutralizing value, a can pressure of between about 7 psi and 12 psi is attained after 24 hours.

When a combination of LEVONA® leavening agent at a 90% neutralizing value and GDL at a 10% neutralizing value is used as the leavening composition, a can pressure of between about 12 psi and 15 psi is attained after 24 hours. When a combination of LEVONA® leavening agent at a 80% neutralizing value and GDL at a 20% neutralizing value is used as the leavening composition, a can pressure of between about 14 psi and 16 psi is attained after 24 hours. When a combination of LEVONA® leavening agent at a 70% neutralizing value and GDL at a 30% neutralizing value is used as the leavening composition, a can pressure of between about 14 psi and 17 psi is attained after 24 hours. When a combination of LEVONA® leavening agent at a 60% neutralizing value and GDL at a 40% neutralizing value is used as the leavening composition, a can pressure of between about 16 psi and 19 psi is attained after 24 hours.

The data plotted in FIG. 3 illustrates the unexpected result that higher pressures in a canned dough product are attained after 24 hours as the ratio of GDL to LEVONA® leavening agent is increased. This unexpected result is due to the fact that the combination of a fast-acting expansion leavening agent such as GDL with a slower-acting pressurization leavening agent such as LEVONA® achieves the desired rate of gas evolution to initially expand the dough and seal the can from within, and then build and sustain pressure in the can by continuing to generate gas within the dough, all without the need for encapsulating or otherwise sequestering the leavening agents.

### Example II

The can pressure and CO₂ evolution of five different canned dough products was measured. The five canned dough products each contained a soft breadstick dough, so each dough formulation was similar, with the only variation being in the type of leavening acids used in each dough. The following leavening acids were used for the five products: 1) GDL at a 100% neutralizing value; 2) CAL-RISE® calcium acid pyrophosphate leavening agent at a 100% neutralizing value; 3) GDL at a 25% neutralizing value; 4) CAL-RISE® leavening agent at a 75% neutralizing value; and, 5) a combination of GDL at a 25% neutralizing value and CAL-RISE® leavening agent at a 75% neutralizing value. Sodium bicarbonate was used as the leavening base, and all the leavening agents were unencapsulated.

The CO₂ evolution of the dough products was measured using a Risograph® instrument, available from National Manufacturing Company, Lincoln, Nebr. The Risograph® instrument measures the volume of gas generated over time. The Risograph® tests were each run twice, due to the potential for leaks resulting in lost data.

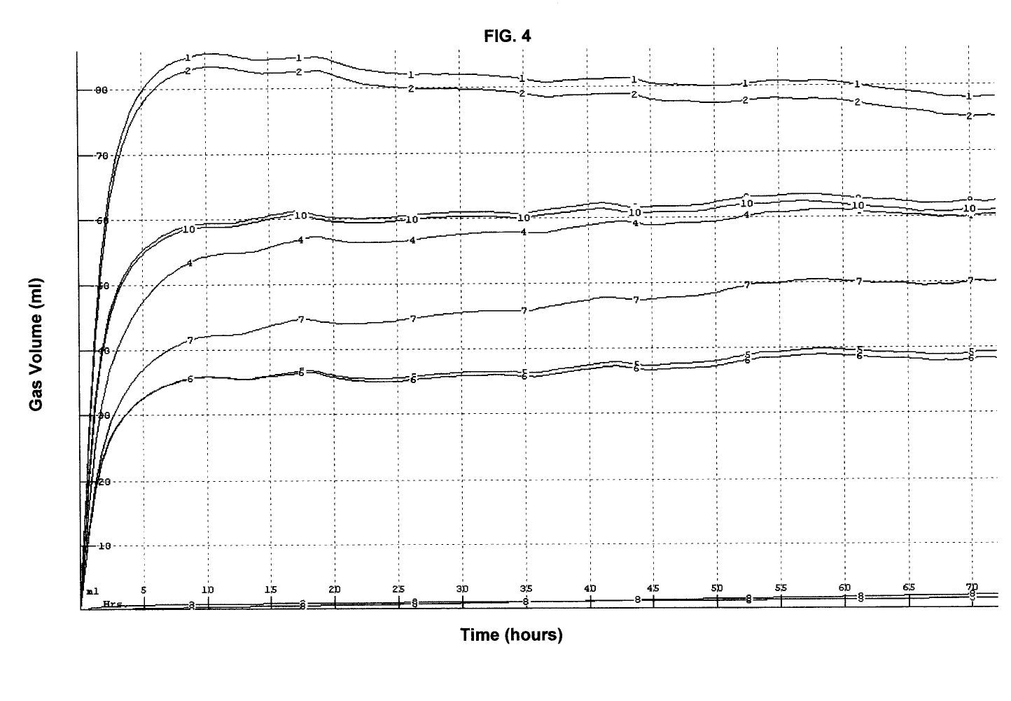

The results of the pressure measurements are summarized in Table 1. The results of the Risograph® tests are shown in FIG. 4. The reference numerals of the FIG. 4 Risograph® plots correspond to the Risograph® chamber reference numerals in Table 1.

TABLE 1
Can Pressure Using GDL and CAL-RISE ® Leavening Agent

| | Risograph ® | Average Weight of | Average Pressure After |
|---|---|---|---|
| Leavening Acid | Chambers | Dough (in gm) | 24 Hours (in psi) |
| GDL - 100% neutralizing value | 1, 2 | 335.5 | 27.6 |
| CAL-RISE ® leavening agent - 100% | 3, 4 | 338.0 | 8.8 |
| neutralizing value | | | |
| GDL - 25% neutralizing value | 5, 6 | 339.2 | 2.5 |
| CAL-RISE ® leavening agent - 75% | 7, 8 | 339.3 | 5.5 |
| neutralizing value | | | |
| Combination: GDL - 25% neutralizing | 9, 10 | 340.2 | 13.0 |
| value and CAL-RISE ® leavening | | | |
| agent - 75% neutralizing value | | | |

The Risograph® data is consistent with the can pressure data. The treatments with faster reaction rates have the greatest gas retention due to faster proofing, which leads to a more rapid sealing of the vents of the can. Therefore, the treatments with faster reaction rates have the highest can pressure.

The treatments wherein the individual leavening acids were at less than 100% neutralizing value produced an inadequate amount of gas for proper dough expansion, gas retention, and can pressurization.

The use of GDL as a leavening agent at a 100% neutralizing value resulted in a very fast reaction. This reaction sealed the cans of dough the most rapidly and resulted in the highest overall can pressure. However, the reaction was faster than is desirable in processing conditions, due to the fast rate of proofing and the excessive can pressure. The fast rate of proofing results in some proofing occurring before the dough is sufficiently packaged, and the excessive can pressure may result in unacceptable package performance or even package failure.

The use of CAL-RISE® leavening agent at a 100% neutralizing value resulted in can pressure that was too low. The leavening agent did not react fast enough to generate the amount of CO₂ necessary for dough proofing for expansion and pressurization, and would result in an unacceptable product.

The use of GDL as a leavening agent at a 25% neutralizing value resulted in a very low can pressure, due to the low level of leavening acid. The use of CAL-RISE leavening agent at a 75% neutralizing value also resulted in a very low can pressure, due to the low level of leavening acid. The CAL-RISE® leavening agent at a 75% neutralizing value produced a slightly lower can pressure than the CAL-RISE leavening agent at a 100% neutralizing value.

The use of the combination of GDL at a 25% neutralizing value and CAL-RISE® leavening agent at a 75% neutralizing value produced a suitable amount of gas for proper dough proofing and gas retention. These results unexpectedly show that the combination of GDL and CAL-RISE® leavening agent is able to generate more gas than the CAL-RISES leavening agent alone, at a 100% neutralizing value. In addition, these results also unexpectedly show that the can pressure attained using a combination of GDL and CAL-RISE® leavening agent is greater than the sum of the pressures attained using either of the GDL and CAL-RISE® leavening agents individually.

While not intending to be bound by theory, it is believed that in addition to the leavening effects of each component, the fast-acting GDL helps acidify and decrease the initial pH of the dough through the rapid neutralization of some of the sodium bicarbonate in the dough, resulting in a lower subsequent pH and thereby increasing the reaction rate of the slower reacting calcium acid pyrophosphate leavening agent. This increased reaction rate results in faster proofing and higher can pressure, resulting in an excellent packaged dough product. The subsequent pH of the dough after the base reacts with the expansion leavening agent, such as GDL, is within the optimal pH range for the calcium acid pyrophosphate leavening agent to react with the base and generate gas within the dough. For a dough containing CAL-RISE® leavening agent, this pH range is about 6 to 8.

### Example III

The can pressure and CO₂ evolution of five different canned dough products was measured. The five canned dough products each contained a soft breadstick dough, so each dough formulation was similar, with the only variation being in the type of leavening acids used in each dough. The following leavening acids were used for the five products: 1) GDL at a 100% neutralizing value; 2) LEVONA® leavening agent at a 100% neutralizing value; 3) GDL at a 25% neutralizing value; 4) LEVONA® leavening agent at a 75% neutralizing value; and, 5) a combination of GDL at a 25% neutralizing value and LEVONA® leavening agent at a 75% neutralizing value. Sodium bicarbonate was used as the leavening base, and all the leavening agents used were unencapsulated.

The CO₂ evolution of the dough products was measured using a Risograph® instrument. The Risograph® tests were each run twice, due to the potential for leaks resulting in lost data.

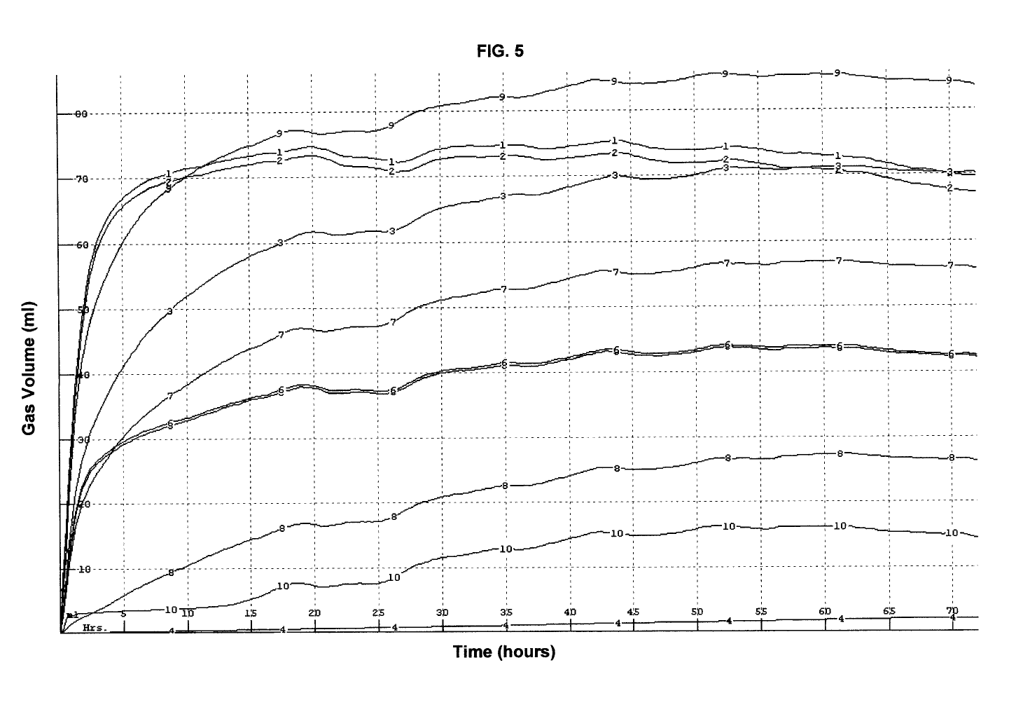

The results of the pressure measurements are summarized in Table 2. The results of the Risograph® tests are shown in FIG. 5. The reference numerals of the FIG. 5 Risograph® plots correspond to the Risograph® chamber reference numerals in Table 2.

TABLE 2
Can Pressure Using GDL and LEVONA ® Leavening Agent

| | Risograph ® | Average Weight of | Average Pressure After |
|---|---|---|---|
| Leavening Acid | Chambers | Dough (in gm) | 24 Hours (in psi) |
| GDL - 100% neutralizing value | 1, 2 | No data | No data |
| LEVONA ® leavening agent - 100% | 3, 4 | 337.9 | 9.8 |
| neutralizing value | | | |
| GDL - 25% neutralizing value | 5, 6 | 334.7 | 0.5 |
| LEVONA ® leavening agent - 75% | 7, 8 | 337.9 | 5.5 |
| neutralizing value | | | |
| Combination: GDL - 25% neutralizing | 9, 10 | 338.3 | 15.4 |
| value and LEVONA ® leavening | | | |
| agent - 75% neutralizing value | | | |

No can pressure data was obtained for the dough products using GDL at a 100% neutralizing value, because the GDL reacted so quickly, the products could not be packaged prior to the reaction.

The Risograph® data is consistent with the can pressure data. The treatments with faster reaction rates have the greatest gas retention due to faster proofing, which leads to a more rapid sealing of the vents of the can. Therefore, the treatments with faster reaction rates have the highest can pressure.

The treatments wherein the leavening acids were at less than 100% neutralizing strength produced an inadequate amount of gas for proper proofing and gas retention.

The use of LEVONA® leavening agent at a 100% neutralizing value resulted in can pressure that was too low. The leavening acid did not react fast enough to generate the amount of CO₂ necessary for dough proofing for expansion or pressurization, and would result in an unacceptable product. As noted above, the use of GDL at a 100% neutralizing value did not result in a useable product due to the extremely fast rate of gas evolution.

The use of GDL as a leavening agent at a 25% neutralizing value resulted in a very low can pressure, due to the low level of leavening acid. The use of LEVONA® leavening agent at a 75% neutralizing value also resulted in a very low can pressure, due to the low level of leavening acid. As expected, LEVONA® leavening agent at a 75% neutralizing value produced a lower can pressure than the LEVONA® leavening agent at a 100% neutralizing value.

The use of the combination of GDL at a 25% neutralizing value and LEVONA® leavening agent at a 75% neutralizing value produced a sufficient amount of gas for proper dough proofing and gas retention. These results unexpectedly show that the combination of GDL and LEVONA® leavening agent is able to generate more gas than the LEVONA® leavening agent alone, at a 100% neutralizing value. In addition, these results also unexpectedly show that the can pressure attained using a combination of GDL and LEVONA® leavening agent is greater than the sum of the pressures attained using the GDL and LEVONA® leavening agents individually.

As discussed above, while not intending to be bound by theory, it is believed that the fast-acting GDL helps acidify and decrease the initial pH of the dough by rapid neutralization of a portion of the sodium bicarbonate, resulting in a lower subsequent pH and thereby increasing the reaction rate of the slower reacting LEVONA® calcium acid pyrophosphate leavening agent. This increased reaction rate results in faster proofing and higher can pressure, resulting in a packaged dough product with excellent shelf life and product properties. The subsequent pH of the dough after the base reacts with the expansion leavening agent, such as GDL, is within the optimal pH range for the calcium acid pyrophosphate leavening agent to react with the base and generate gas within the dough. For a dough containing LEVONA® leavening agent, the pH range for reacting with the base is about pH 6 to about pH 8.

Although the present invention and it advantages have been described in detail, it should be understood that various changes, substitutions and alterations can be made herein without departing from the spirit and scope of the invention as defined by the appended claims. Moreover, the scope of the present application is not intended to be limited to the particular embodiments of the invention described in the specification. As one of ordinary skill in the art will readily appreciate from the disclosure of the present invention, the compositions, processes, methods, and steps, presently existing or later to be developed that perform substantially the same function or achieve substantially the same result as the corresponding embodiments described herein may be utilized according to the present invention.

What is claimed is:

1. A refrigerated dough system, comprising a dough product inside a package, said dough product comprising:
a base;
an expansion leavening acid capable of generating gas when combined with the base to initially expand the dough product to a degree sufficient to seal the package from within the package; and
a pressurization leavening acid capable, when combined with the base, of generating gas within the dough product to subsequently pressurize the dough product inside the sealed package in an amount sufficient to sustain an internal system pressure inside the package under refrigeration conditions over a period of time;
said base, expansion leavening acid and pressurization leavening acid each being unencapsulated;
wherein the internal system pressure is less than a pressure sustained by the expansion leavening acid at a 100% neutralizing value in a similar dough, and greater than a pressure sustained by the pressurization leavening acid at a 100% neutralizing value in a similar dough, inside the package under the refrigeration conditions for the period of time.

2. The refrigerated dough system of claim 1, wherein the internal pressure ranges from about 8 psi to about 28 psi.

3. The refrigerated dough system of claim 1, wherein the internal pressure ranges from about 10 psi to about 20 psi.

4. The refrigerated dough system of claim 1, wherein the expansion leavening acid and the pressurization leavening acid are present in the dough at a ratio of from about 10:90 to about 40:60 prior to reacting with the base.

5. The refrigerated dough system of claim 1, wherein at least one of the expansion leavening acid and the pressurization leavening acid is substantially free of sodium.

6. The refrigerated dough system of claim 1, wherein the expansion leavening acid is a fast-acting leavening agent selected from the group consisting of glucono-delta-lactone and sodium acid pyrophosphate.

7. The refrigerated dough system of claim 1, wherein the pressurization leavening acid is a slow-acting leavening agent comprising calcium acid pyrophosphate.

8. The refrigerated dough system of claim 1, wherein the period of time ranges from about 30 days to about 120 days.

9. The refrigerated dough system of claim 1, wherein the package is a composite can.

10. The refrigerated dough system of claim 1, wherein the expansion leavening acid expands the dough product at a temperature ranging from about 40° F. to about 70° F.

11. A method for making a refrigerated dough product, comprising the steps of:
mixing dough ingredients comprising an unencapsulated leavening base, an unencapsulated expansion leavening acid, and an unencapsulated pressurization leavening acid together to make a dough;
placing the dough inside a ventable package with an opening;
closing the opening of the package to create a headspace comprising air inside the package;
sealing the package from within the package by action of the expansion leavening acid and the base together generating gas in the dough to expand the dough, thereby venting out the air in the headspace and filling the headspace with expanded dough; and
generating pressure inside the package from within the package by action of the pressurization leavening acid and the base together generating additional gas in the expanded dough.

12. The method of claim 11, further comprising the step of storing the refrigerated dough product at a temperature ranging from about 40° F. to about 70° F.

13. The method of claim 12, wherein the dough is stored for a period of time ranging from about 1 day to about 120 days.

14. The method of claim 11, wherein sealing the package occurs within about 24 hours to about 72 hours after the dough is placed inside the package.

15. The method of claim 11, wherein the pressure generated within the package ranges from about 8 psi to about 28 psi.

16. The method of claim 11, wherein the pressure generated within the package ranges from about 10 psi to about 20 psi.
